(19) United States
(12) Patent Application Publication
(10) Pub. No.: US 2016/0320881 A1
(43) Pub. Date: Nov. 3, 2016

(54) Using Touch Sensors as an Electromagnetic Shield

(71) Applicant: NOKIA TECHNOLOGIES OY, Espoo (FI)

(72) Inventors: Jyri Rauhala, Tampere (FI); Hannu Haapakoski, Salo (FI); Vicente Calvo Alonso, Piispanristi (FI); Marko Heikkinen, Tampere (FI)

(21) Appl. No.: 15/108,858

(22) PCT Filed: Nov. 25, 2014
(86) PCT No.: PCT/FI2014/050903

§ 371 Date: Jun. 29, 2016

(30) Foreign Application Priority Data
Dec. 30, 2013 (GB) 1323106.3

(51) Int. Cl. G06F 3/046; G06F 3/041; G06F 3/044

(52) U.S. Cl. CPC G06F 3/046; G06F 3/044; G06F 3/0416; G06F 3/0412; G06F 2203/04103

(57) ABSTRACT

An apparatus and a method of manufacturing the apparatus is provided. The apparatus includes a sensing layer including an array of touch sensors for sensing touch input; and a trace layer including a plurality of traces that electrically connect the touch sensors to sensing circuitry, wherein the array of touch sensors in the sensing layer is positioned to electromagnetically shield the plurality of traces, in the trace layer, from conductive user input objects.

### TECHNOLOGICAL FIELD

Embodiments of the present invention relate to using touch sensors as an electromagnetic shield. In particular, they relate to using touch sensors in a capacitive touch sensitive display as an electromagnetic shield.

### BACKGROUND

A capacitive touch sensitive display comprises sensing circuitry which drives a plurality of sensors, creating an electrostatic field. When a conductive object, such as a user's finger or a stylus, is positioned on (or close to) the display, the electrostatic field is distorted. This distortion enables the sensing circuitry to determine the location of the conductive object on the display.

### BRIEF SUMMARY

According to various, but not necessarily all, embodiments of the invention there is provided an apparatus, comprising: a sensing layer comprising an array of touch sensors for sensing touch input; and a trace layer comprising a plurality of traces that electrically connect the touch sensors to sensing circuitry, wherein the array of touch sensors in the sensing layer is positioned to electromagnetically shield the plurality of traces, in the trace layer, from conductive user input objects.

According to various, but not necessarily all, embodiments of the invention there is provided a method, comprising: forming a sensing layer comprising an array of touch sensors for sensing touch input; and forming a trace layer comprising a plurality of traces that electrically connect the touch sensors to sensing circuitry, wherein the array of touch sensors in the sensing layer is positioned to electromagnetically shield the plurality of traces, in the trace layer, from conductive user input objects.

### BRIEF DESCRIPTION

For a better understanding of various examples that are useful for understanding the detailed description, reference will now be made by way of example only to the accompanying drawings in which:

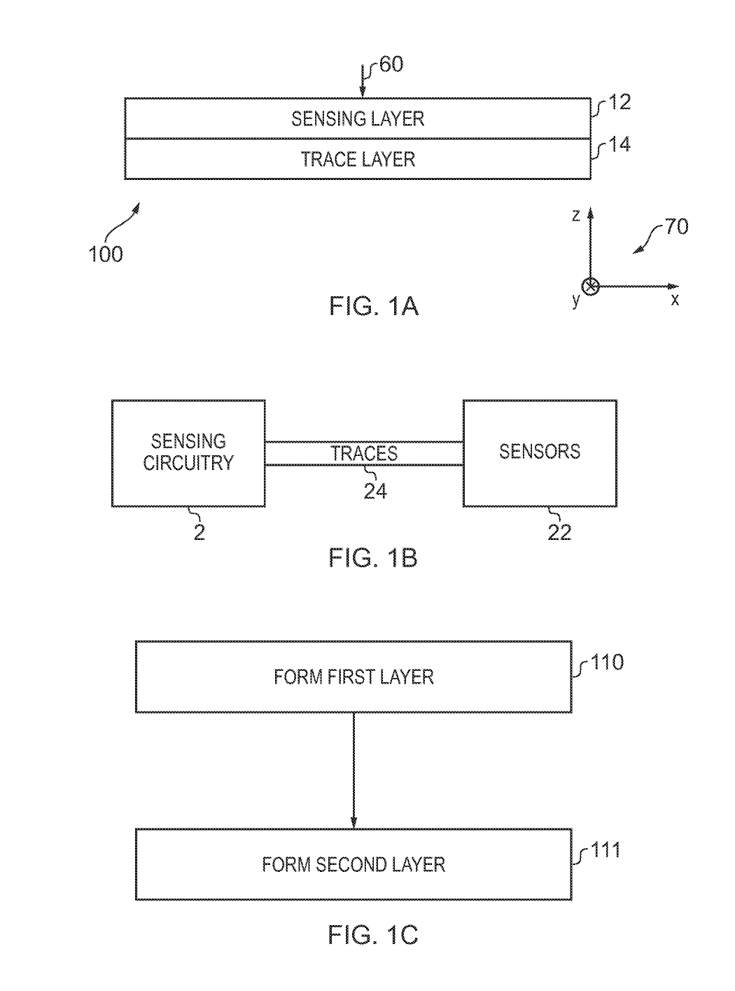

FIG. 1A illustrates a schematic of an apparatus which forms part of a touch sensitive display;

FIG. 1B illustrates sensing circuitry electrically connected to sensors in the sensing layer by traces;

FIG. 1C illustrates a flow chart of a method for manufacturing the apparatus illustrated in FIG. 1A;

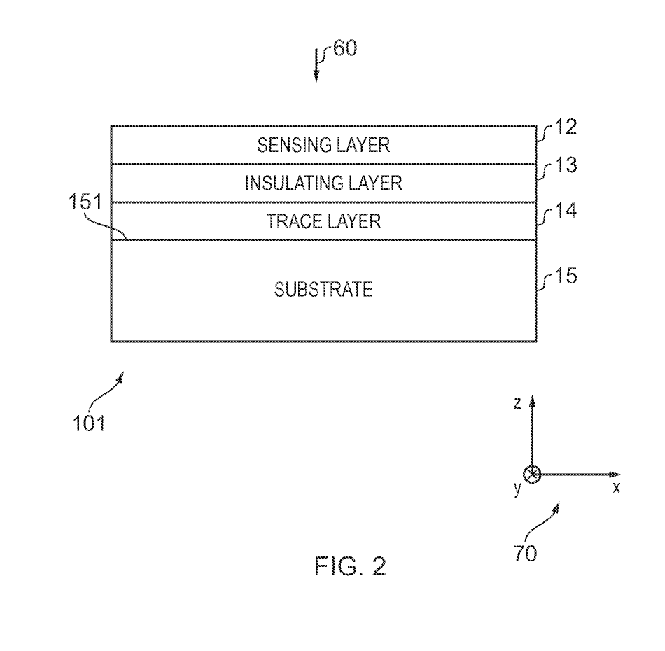

FIG. 2 illustrates a schematic of a first embodiment of the apparatus;

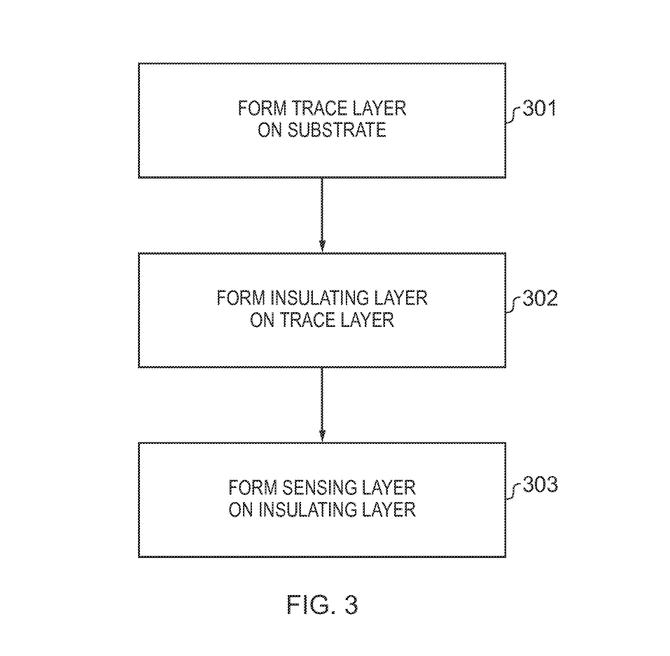

FIG. 3 illustrates a flow chart of a method of manufacturing the first embodiment of the apparatus;

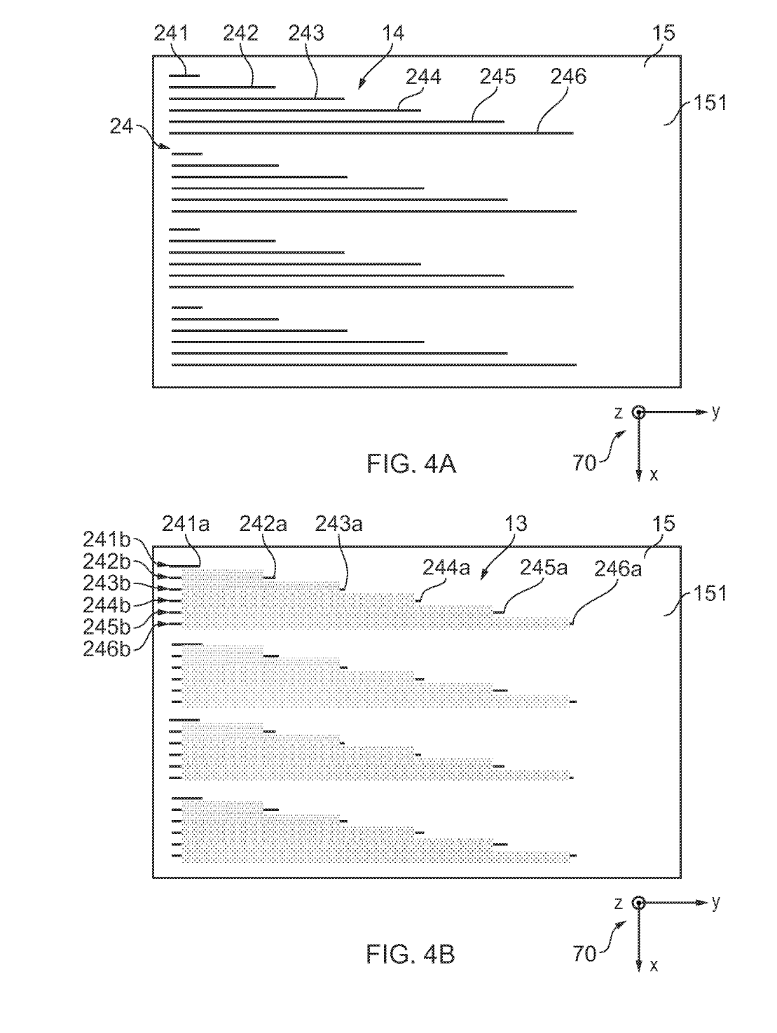

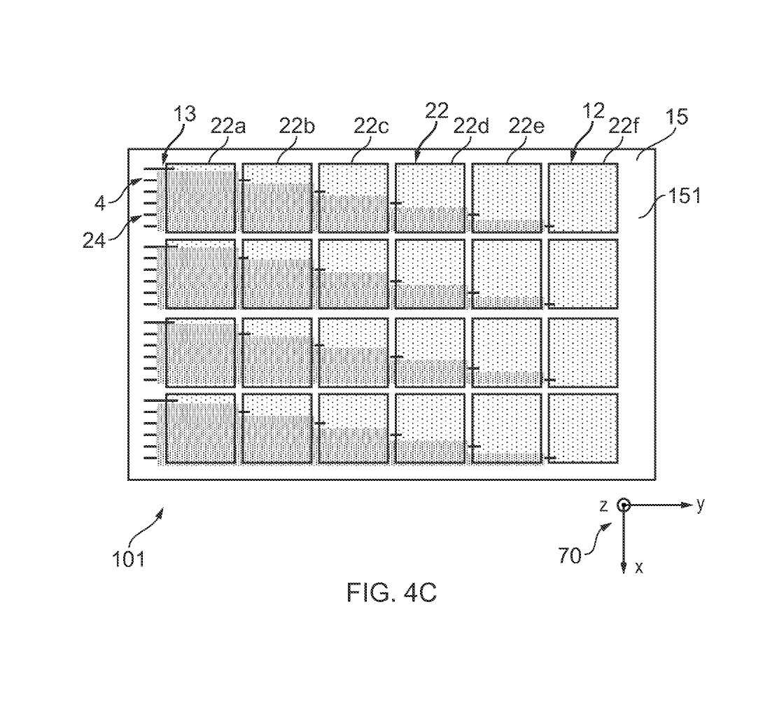

FIG. 4A illustrates a trace layer formed on a substrate;

FIG. 4B illustrates an insulating layer formed on the trace layer;

FIG. 4C illustrates a sensing layer formed on the insulating layer, forming a first example of the first embodiment of the apparatus illustrated in FIG. 3;

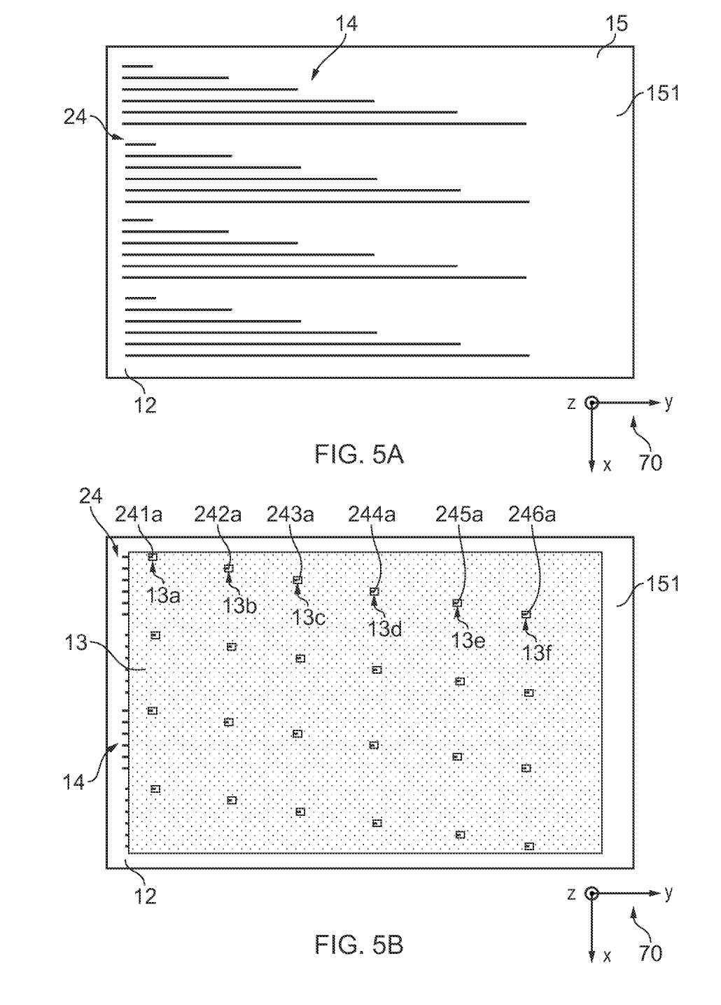

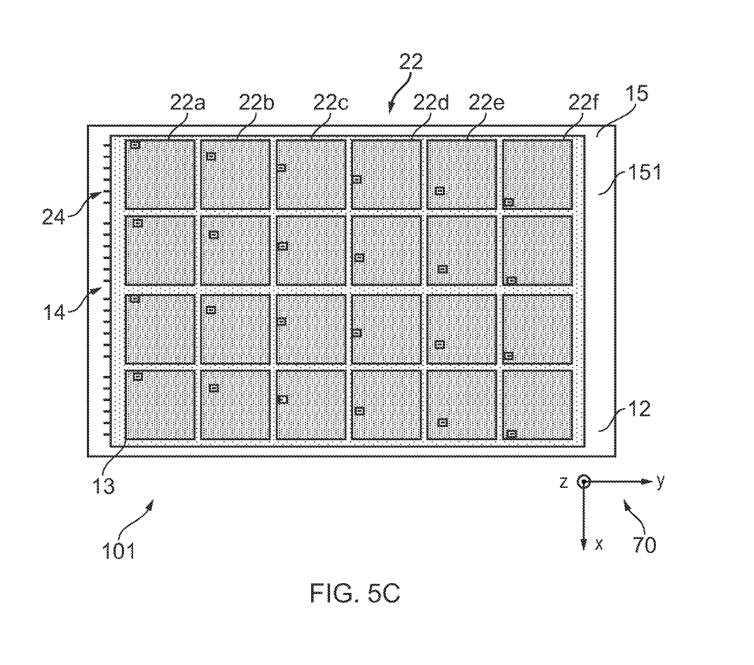

FIG. 5A illustrates a trace layer formed on a substrate;

FIG. 5B illustrates an insulating layer formed on the trace layer;

FIG. 5C illustrates a sensing layer formed on the insulating layer, forming a second example of the first embodiment of the apparatus illustrated in FIG. 3;

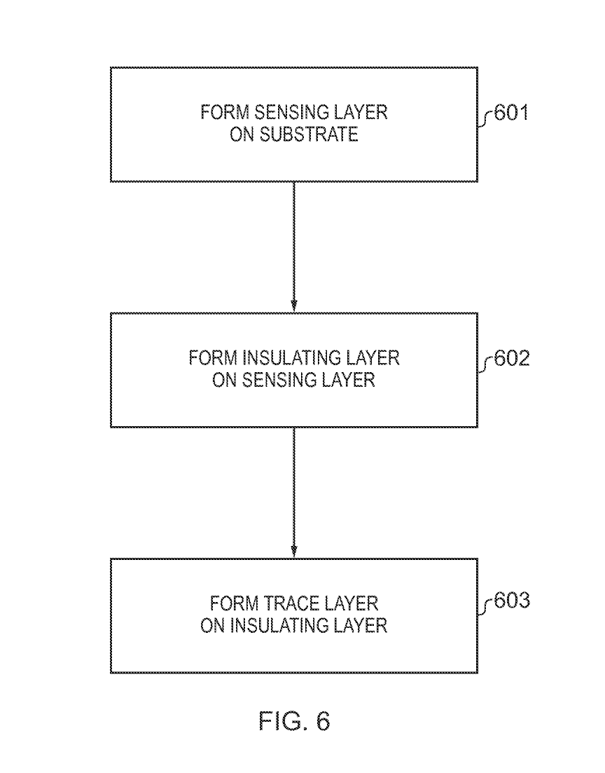

FIG. 6 illustrates a flow chart of a method of manufacturing a second embodiment of the apparatus;

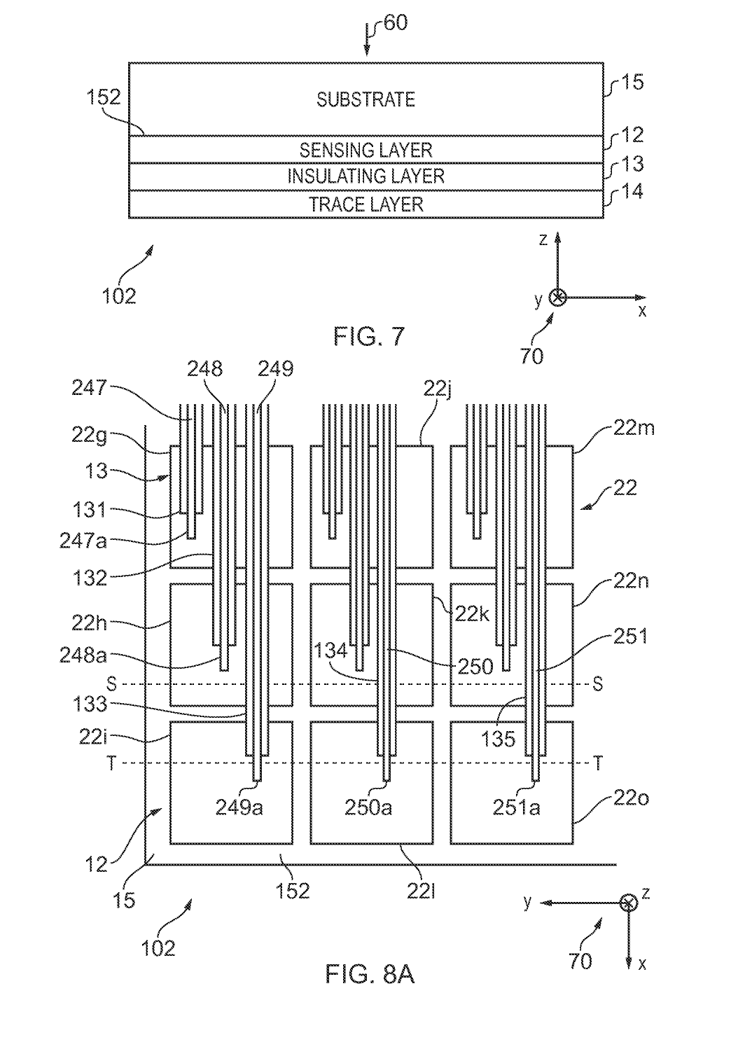

FIG. 7 illustrates a schematic of the second embodiment of the apparatus;

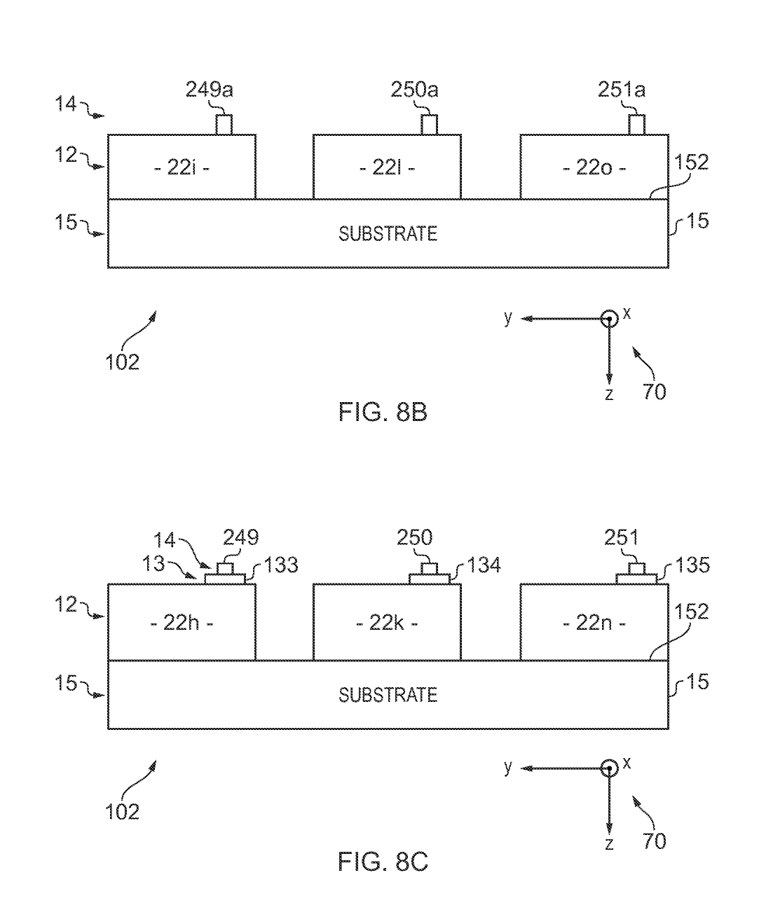

FIG. 8A illustrates a view, from beneath the apparatus, of a first example of the second embodiment of the apparatus;

FIG. 8B illustrates a first cross section of the first example of the second embodiment of the apparatus, taken across the line T-T illustrated in FIG. 8A;

FIG. 8C illustrates a second cross section of the first example of the second embodiment of the apparatus, taken across the line S-S illustrated in FIG. 8A;

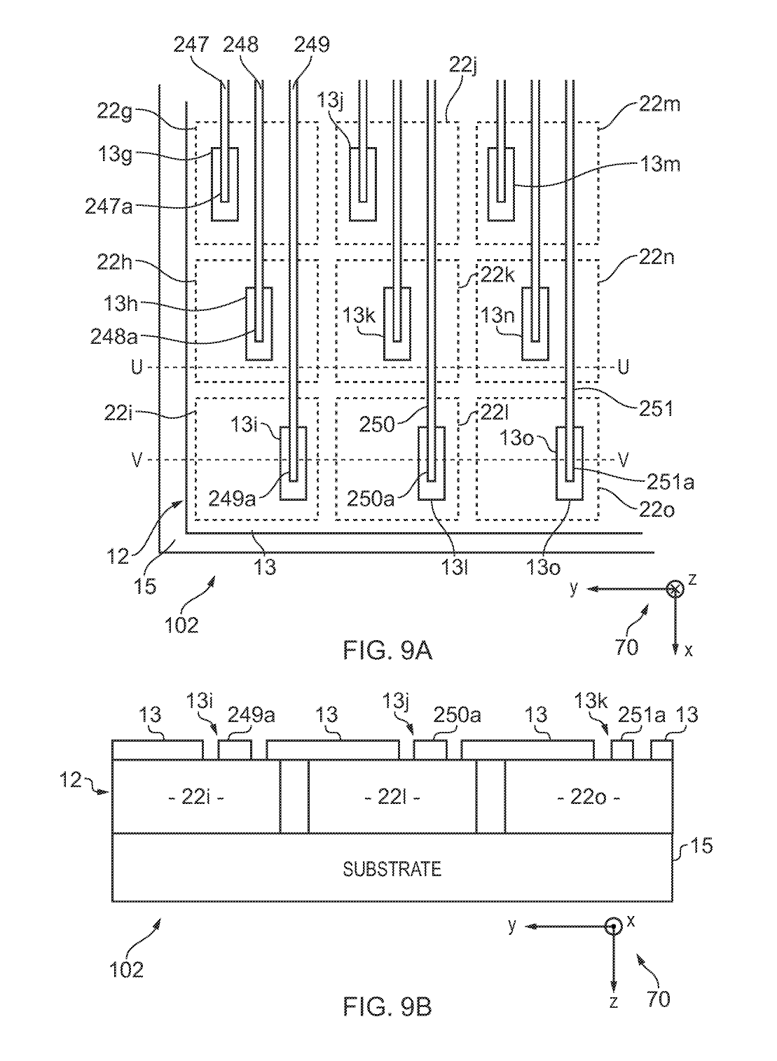

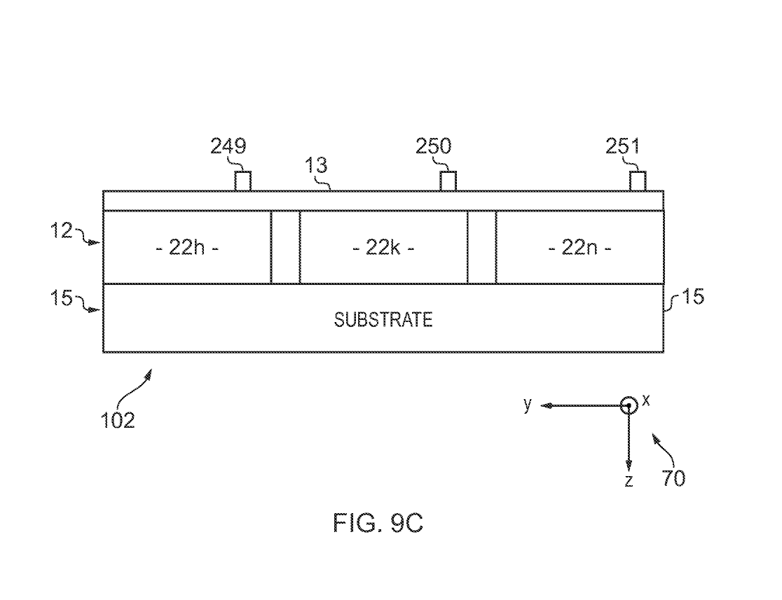

FIG. 9A illustrates a view, from beneath the apparatus, of a second example of the second embodiment of the apparatus;

FIG. 9B illustrates a first cross section of the second example of the second embodiment of the apparatus, taken across the line V-V illustrated in FIG. 9A;

FIG. 9C illustrates a second cross section of the second example of the second embodiment of the apparatus, taken across the line U-U illustrated in FIG. 9A; and

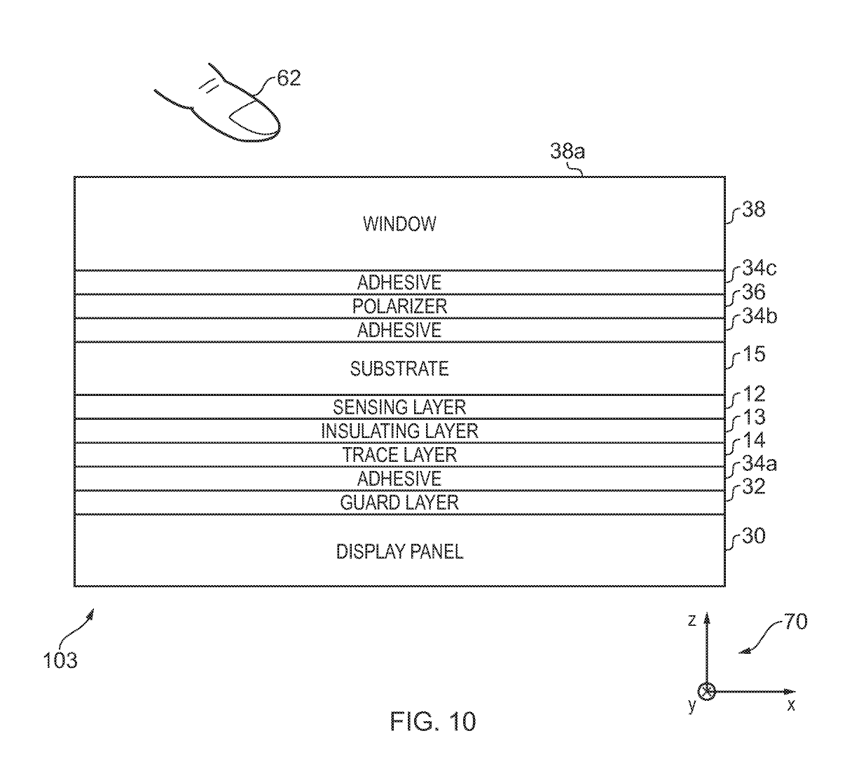

FIG. 10 illustrates an electronic device comprising the apparatus.

### DETAILED DESCRIPTION

FIG. 1A illustrates a schematic of an apparatus 100. The apparatus 100 may, for example, form part of a touch sensitive display. Cartesian coordinate axes 70 have been included in FIG. 1A and a number of the other figures to assist the reader in orientating one figure relative to another. In FIG. 1A, the x-axis and the z-axis are perpendicular to one another and parallel to the page. The y-axis is perpendicular to both the x-axis and the y-axis and is directed into the page.

The apparatus 100 comprises a sensing layer 12 and a trace layer 14. The sensing layer 12 comprises an array of touch sensors/pads 22. The touch sensors 22 are electrodes. They may, for instance, be arranged in a grid.

The trace layer 14 comprises a plurality of conductive traces 24 that electrically connect the touch sensors 22 to sensing circuitry 2. A trace may be provided in the trace layer 14 for each and every sensor in the sensing layer 12, where each individual trace connects a single sensor to the sensing circuitry 2. FIG. 1B schematically illustrates the sensing circuitry 2 electrically connected to the sensors 22 by the traces 24.

The sensing layer 12 and the trace layer 14 may both be formed from one or more conductive materials. The materials may be inherently transparent, or inherently non-transparent but substantially invisible to a viewer due to the nature/size of the sensors 22/traces 24. Materials such as indium tin oxide (ITO), silver nanowire or carbon nanowire may be used.

The touch sensors 22 in the sensing layer 12 are for sensing touch input from one or more conductive input objects, such as a user digit and/or a stylus. The sensing circuitry 2 may, for example, comprise drive circuitry which drives the sensors 22 in the sensing layer 12, causing the sensors 22 to produce an electrostatic field. User input is sensed by the sensing circuitry when one or more conductive input objects are placed close to the one or more sensors 22 in the sensing layer 12, distorting the electrostatic field. This may occur, for example, when one or more conductive user input objects are moved towards the apparatus 100 in the direction illustrated by the arrow labelled with the reference numeral 60 in FIG. 1A, and positioned close to one or more of the sensors 22 in the sensing layer 12.

In the schematic illustrated in FIG. 1A, the width of the sensing layer 12 and the width of the trace layer 14 is aligned with the x-axis. The length of the sensing layer 12 and the length of the trace layer 14 are aligned with the y-axis. The depth of the sensing layer 12 and the depth of the trace layer 14 are aligned with the z-axis.

The sensing layer 12 is positioned above the trace layer 14 in FIG. 1A. The sensing layer 12 is in contact with the trace layer 14. That is, the traces 24 in the trace layer 14 are in contact with the sensors 22 in the sensing layer 12.

The length of the sensing layer 12 is the same or greater than the width of the sensing layer 12. The depth of the sensing layer 12 is (much) smaller than both the length and the width of the sensing layer 12.

The length of the trace layer 14 is the same or greater than the width of the trace layer 14. The depth of the trace layer 14 is (much) smaller than both the length and the width of the trace layer 14.

FIG. 10 illustrates a flow chart for a method for manufacturing the apparatus 100 illustrated in FIG. 1A. In block 110 of FIG. 10, a first layer of the apparatus 100 is formed. In block 111 of FIG. 10, a second layer of the apparatus 100 is formed. In some examples, the sensing layer 12 is formed in block 110 of FIG. 1 C, prior to the formation of the trace layer 14 in block 111 of FIG. 10. In other examples, the trace layer 14 is formed in block 110 of FIG. 10, prior to the formation of the sensing layer 12 in block 111 of FIG. 10. This will be described in more detail below.

FIG. 2 illustrates a schematic of a first embodiment 101 of the apparatus 100 illustrated in FIG. 1A. The illustrated first embodiment 101 comprises a sensing layer 12, an insulating layer 13, a trace layer 14 and a substrate 15. Cartesian coordinate axes 70 are illustrated in FIG. 2 in which the x-axis and the z-axis are parallel to the page and they-axis is directed into the page.

The insulating layer 13 is formed from an electrical insulator and is positioned between the sensing layer 12 and the trace layer 14. The insulating layer 13 is substantially transparent.

The length of the insulating layer 13 is the same or greater than the width of the insulating layer 13. The depth of the insulating layer 13 is (much) smaller than both the length and the width of the insulating layer 13.

The length of the substrate 15 is the same or greater than the width of the substrate 15. The depth of the substrate 15 is smaller than both the length and the width of the substrate 15. In the illustrated example, the depth/thickness of the substrate 15 is greater than the depth/thickness of each of: the sensing layer 12, the insulating layer 13 and the trace layer 14.

The substrate 15 supports the trace layer 14, the insulating layer 13 and the sensing layer 12. The substrate 15 provides strength and rigidity to the first embodiment 101 of the apparatus 100. The substrate 15 may, for example, be made from glass or a plastics material such as polyethylene terephthalate (PET), polycarbonate (PC) or a cyclic olefin copolymer (COP). The substrate 15 is substantially transparent.

A first example of a method of manufacturing the first embodiment 101 of the apparatus 100 will now be described in relation to FIGS. 3 to 4C. At block 301 in FIG. 3, the trace layer 14 is formed on a face 151 of the substrate 15 defined by the length and width of the substrate 15. In forming the trace layer 14, the traces 24 may be sputtered or printed onto the face 151 of the substrate 15. In this example, an individual trace is formed (for example, via a photolithography process or by selective printing process) on the substrate 15 for each sensor 22 that will be present in the sensing layer 12.

The trace layer 14 may only partially cover the face 151 of the substrate 15. That is, a portion of the substrate 15 is covered with traces 24 and a portion is left exposed (uncovered). The area that is left exposed may be greater than the area which is covered by the traces 24.

In FIG. 4A, the x-axis and the y-axis are parallel to the plane of the page and the z-axis is directed out of the page. Six individual traces have been marked with the reference numerals 241, 242, 243, 244, 245 and 246 in FIG. 4A. In the illustrated example, each trace is a straight line. However, the traces might not be straight lines in other examples.

The traces labelled with the reference numerals 241, 242, 243, 244, 245, 246 are all of a different length. This is because each of these traces 241-246 will electrically connect to a different sensor in a particular column in an array of sensors 22. In the illustrated example, a column in the array of sensors 22 is aligned with the y-axis, and a row in the array of sensors 22 is aligned with the x-axis.

At block 302 in FIG. 3, the insulating layer 13 is formed on the trace layer 14. The insulating layer 13 only partially covers the trace layer 14—the ends of each trace are left exposed. In the example illustrated in FIG. 4B, a portion of the face 151 is left exposed. That is, it is not covered by the traces 24 in the trace layer 14 nor the insulating layer 13.

One end of an individual trace is electrically connected to the sensing circuitry 2, and the other end is connected to a sensor. Each trace is connected to a different one of the sensors 22. In FIG. 4B, the traces labelled with the reference numerals 241, 242, 243, 244, 245, and 246 have exposed ends labelled with the reference numerals 241a, 242a, 243a, 244a, 245a, and 246a which are for connection to sensors 22 in the sensing layer 12. These traces 241-246 also have exposed ends labelled with the reference numerals 241b, 242b, 243b, 244b, 245b and 246b which are for connection to the sensing circuitry 2.

At block 303 in FIG. 3, the sensing layer 12 is formed on the insulating layer 13/substrate 15. At least some of the sensors 22 in the sensing layer 12, and/or some parts of some sensors 22 in the sensing layer 12, may be formed directly on top of the insulator 13. Some sensors 22 in the sensing layer 12, and/or some parts of some sensors in the sensing layer 12, may be formed directly on the exposed/uncovered portion of the face 151 of the substrate 15, as shown in FIG. 4C. The sensing layer 12 may, for example, be sputtered onto the insulating layer 13/substrate 15.

Each sensor in the sensing layer 12 is in contact with (and therefore is electrically connected to) an exposed end of a trace in the trace layer 14. In FIG. 4C, first, second, third, fourth, fifth and sixth sensors in a column of the sensor array are labelled with the reference numerals 22a, 22b, 22c, 22d, 22e and 22f. The first, second, third, fourth, fifth and sixth sensors 22a-22f are directly connected to first, second, third, fourth, fifth and sixth traces 241-246 respectively via the exposed ends 241a-246a of those traces 241-246.

There is an individual trace for each and every sensor in the sensor array which electrically connects the sensors 22a-22f to the sensing circuitry 2. The insulating layer 13 electrically insulates a sensor from all of the other traces positioned beneath it.

In a second example of the method of manufacturing the first embodiment 101 of the apparatus 100, the trace layer 14 is formed in the same manner as that discussed above in relation to block 301 in FIG. 3 and FIG. 4A, as shown in FIG. 5A. However, in this second example of the method, the insulating layer 13 has a different shape from that illustrated in FIG. 4B. In the second example, the insulating layer 13 is also formed over the trace layer 12 at block 302 in FIG. 3 but, in this example, the insulating layer 13 covers much more of the face 151 of the substrate 15. For example, in circumstances where the substrate 15 overlies (or is to overlie) a display panel, substantially the whole of the area which overlies the (pixels in the) display panel is covered by the insulating layer 13.

Covering the face 151 of the substrate 15 in this manner may advantageously result in a more optically homogenous touch sensitive display being produced. This is because, while the insulating layer 13 is substantially transparent, it is possible that a viewer may be able to see the edges of the insulating layer 13 in the FIG. 4B example if he looks closely.

Some apertures are formed in the insulating layer 13 which enable the traces underneath to electrically connect to the sensor layer 12 when it is formed on top of the insulating layer 13. FIG. 5B illustrates six apertures labelled with the reference numerals 13a, 13b, 13c, 13d, 13e and 13f which each expose a portion 241a, 242a, 243a, 244a, 245a, 246a of a different trace. Each exposed trace portion 241a, 242a, 243a, 244a, 245a, 246a contacts, and electrically connects to, a different sensor when the sensing layer 12 is formed on the insulating layer 13.

FIG. 5C illustrates the sensing layer 12 formed on the insulating layer 13. In FIG. 5C, first, second, third, fourth, fifth and sixth sensors in a column of the sensor array are labelled with the reference numerals 22a, 22b, 22c, 22d, 22e and 22f. The first, second, third, fourth, fifth and sixth sensors 22a-22f are electrically connected to first, second, third, fourth, fifth and sixth traces 241-246 respectively via the exposed ends 241a-246a of those traces 241-246.

FIG. 6 illustrates a flow chart for manufacturing a second embodiment 102 of the apparatus 100. A schematic of the second embodiment 102 is illustrated in FIG. 7. Cartesian coordinate axes 70 are illustrated in FIG. 7 in which the x-axis and the z-axis are parallel to the page and the y-axis is directed into the page.

The second embodiment 102 of the apparatus 100 differs from the first embodiment 101 in that the sensing layer 12, the insulating layer 13 and the trace layer 14 are positioned beneath the substrate 15 rather than above the substrate 15. That is, the layers 12, 13, 14 are stacked on its lower face rather than its upper face.

The ordering of the sensing layer 12, the insulating layer 13 and the trace layer 14 is the same as that in the first embodiment 101. That is, the sensing layer 12 is positioned above the insulating layer 13 and the trace layer 14, and is the positioned closer to potential user input objects (which may be brought towards the apparatus 102 in the direction indicated by the arrow 60 in FIG. 7) than the insulating layer 13 and the trace layer 14. The insulating layer 13 is again positioned between the sensing layer 12 and the trace layer 14.

In the second embodiment 102, as in the first embodiment 101, the substrate 15 supports the trace layer 14, the insulating layer 13 and the sensing layer 12. The substrate 15 provides strength and rigidity to the apparatus 102. The substrate 15 could, for example, be the front window of a device (such as a mobile telephone or a tablet computer) in which the second embodiment 102 of the apparatus 100 is incorporated.

The second embodiment 102 is formed differently from the first embodiment 101 in that the sensing layer 12 is formed prior to the trace layer 14. At block 601 in FIG. 6, the sensing layer 12 is formed on a face 152 of the substrate 15. At block 602 in FIG. 6, the insulating layer 13 is formed on the sensing layer 12. At block 603 in FIG. 6, the trace layer 14 is formed on the insulating layer 13.

A first example of the second embodiment 102 of the apparatus is illustrated in FIGS. 8A, 8B and 8C. FIG. 8A illustrates a view, from beneath the apparatus, of the first example of the second embodiment 102. That is, a view as seen when looking in the +z direction indicated by the Cartesian coordinate axes 70.

The sensing layer 12 may have the same form as that described above in relation to FIGS. 1A, 2 and 4C. FIG. 8A illustrates an array of sensors 22g, 22h, 22i, 22j, 22k, 221, 22m, 22n, 22o which have been formed on a face 152 of the substrate 15.

The trace layer 14 may have the same form as that described above in relation to FIGS. 4A and 5A.

The shape of the insulating layer 13 depends upon the shape of the traces 24 in the trace layer 14. This is because portions of the insulating layer 13 insulate individual traces from sensors, or parts of sensors, in the sensing layer 12. The insulating layer 13 may be of the same shape as the insulating layer 13 in the first example of the first embodiment 101, as illustrated in FIG. 4B.

In the first example of the second embodiment 102 illustrated in FIG. 8A, a portion 131 of the insulating layer 13 follows substantially the same path on the face 152 of the substrate 15 as the trace labelled with the reference numeral 247. The portion 131 of the insulating layer 13 is shaped to enable an end portion 247a of the trace 247 to contact, and therefore electrically connect with, a sensor 22g. Another portion 132 of the insulating layer 13 electrically insulates a trace 248 from a sensor 22g because it is positioned between the trace 248 and the sensor 22g. That portion 132 is shaped to allow an end portion 248a of the trace 248 to contact, and therefore electrically connect to, another sensor 22h.

Similarly, a further portion 133 of the insulating layer 13 insulates a trace 249 from a plurality of sensors 22g, 22h, but is shaped to allow an end portion 249a of the trace 249 to contact, and therefore electrically connect to, a further sensor 22i.

FIG. 8B illustrates a first cross section of the first example of the second embodiment 102 of the apparatus, taken across the line T-T illustrated in FIG. 8A. FIG. 8B illustrates the end portions 249a, 250a, 251 a of three traces 249, 250, 251 in contact with three sensors 22i, 221, 22o.

FIG. 8C illustrates a second cross section of the first example of the second embodiment 102 of the apparatus, taken across the line S-S illustrated in FIG. 8A. FIG. 8C illustrates three portions 133, 134, 135 of the insulating layer 13 insulating three traces 249, 250, 251 from three sensors 22h, 22k, 22n in the sensing layer 12.

A second example of the second embodiment 102 of the apparatus is illustrated in FIGS. 9A, 9B and 9C. FIG. 9A illustrates a view, from beneath the apparatus, of the second example of the second embodiment 102. That is, a view as seen when looking in the +z direction indicated by the Cartesian coordinate axes 70.

The sensing layer 12 in the second example of the second embodiment 102 may have the same form as that described above in relation to FIGS. 1A, 2, 4C and 8A. Dotted lines in FIG. 9A illustrate an array of sensors 22g, 22h, 22i, 22j, 22k, 221, 22m, 22n, 22o, positioned underneath an insulating layer 13, which have been formed on a face 152 of the substrate 15.

The insulating layer 13 in the second example of the second embodiment 102 may have the same form as the insulating layer 13 described above in relation to FIG. 5B. An individual aperture 13g, 13h, 13i, 13j, 13k, 13m, 13n, 13o is provided in the insulating layer 13 for each sensor 22g, 22h, 22i, 22j, 22k, 22m, 22n, 22o to enable an end portion of a trace to contact, and therefore electrically connect to, a sensor 22g-22o in the sensing layer 12.

The trace layer 14 in the second example of the second embodiment 102 may have the same form as that described above in relation to FIGS. 4A and 5A.

FIG. 9B illustrates a first cross section of the second example of the second embodiment 102 of the apparatus, taken across the line V-V illustrated in FIG. 9A. FIG. 9B illustrates the end portions 249a, 250a, 251a of three traces 249, 250, 251 in contact with three sensors 22i, 221, 22o through apertures 13i, 131, 13j, 13o in the insulating layer 13.

FIG. 9C illustrates a second cross section of the second example of the second embodiment 102 of the apparatus, taken across the line U-U illustrated in FIG. 9A. FIG. 9C illustrates the insulating layer 13 insulating three traces 249, 250, 251 from three sensors 22h, 22k, 22n in the sensing layer 12.

FIG. 10 illustrates a touch sensitive display apparatus 103 comprising the apparatus 100. Cartesian coordinate axes 70 are illustrated in FIG. 10 in which the x-axis and the z-axis are parallel to the page and the y-axis is directed into the page. In the illustration, the second embodiment 102 of the apparatus 100 is shown, but the touch sensitive display apparatus 103 could include the first embodiment 101 of the apparatus 100 instead.

The touch sensitive display 102 further comprises a display window 38, at least one polarizer 36, a guard layer 32 and a display panel 30. Each of the display window 38, the polarizer(s) 36 and the guard layer 32 is substantially transparent.

A lower face of the polarizer 36 is attached to an upper face of the substrate using an optically clear adhesive 34b. An upper face of the polarizer 36 is attached to a lower face of a display window 38 using an optically clear adhesive 34c. The display window 38 has an upper face 38a which is the outermost surface of the touch sensitive display apparatus 103. A user may provide touch input using a conductive user input object 62 by touching the outer surface 38a of the display window 38 (or by bringing it close enough to the outer surface 38a to be detected by the touch sensors 22).

A guard layer 32 is attached to the underside of the second embodiment 102 of the apparatus using an optically clear adhesive 34a, such that it is positioned below the trace layer 14. The guard layer 32 is positioned above the display panel 30.

The guard layer 32 is configured to electromagnetically shield the sensors 22 in the sensing layer 12 from electromagnetic noise emanating from the display panel 30 (or emanating from other electronics in a device in which the touch sensitive display 103 is integrated).

The display panel 30 is an electronic display panel comprising an array of pixels. The pixels are arranged in rows and columns. The display panel 30 could be any type of display panel, such as a liquid crystal display (LCD) panel, an organic light emitting diode (OLED) panel or a quantum dot panel.

In operation, since the sensing layer 12 is positioned between a conductive user input object 62 and the traces 24 in the trace layer 14, the sensors 22 in the sensing layer 12 electromagnetically shield the traces 24 from the conductive user input object 62. This prevents/mitigates capacitive coupling between the conductive user input object 62 and the traces 24 in the trace layer 14, which would otherwise generate noise in the signals sensed by the sensing circuitry 2.

Thus, advantageously, noise in the signals carried by the traces 24 and sensed by the sensing circuitry 2 is reduced, without a need for an additional guard layer positioned between the sensing layer 12 and the conductive user input object 62 (which would increase the thickness of the touch sensitive display apparatus 103).

The traces 24 in the trace layer 14 occupy a given surface area, above the (pixels in the) display panel 30, in an x-z plane. In some instances, the sensors 22 in the sensing layer 12 may cover/overlie at least 70% of that surface area. In other instances, the sensors 22 in the sensing layer 12 may cover/overlie at least 90% of that surface area. In some further instances, the sensors in the sensing layer 12 may cover/overlie the whole of that surface area.

Since the traces 24 are situated in a different layer from the sensors 22 (rather than in the same layer), it is possible to allocate a greater area in an x-y plane to the sensors 22, potentially resulting in more accurate sensing. A further advantage to having the traces 24 in a different layer from the sensors 22, rather than the same layer, is that a border around the sensors 22 including traces need not be present, enabling the border/“deadband” around the touch sensitive display apparatus 103 to be reduced.

As used in this application, the term ‘circuitry’ refers to all of the following:

(a) hardware-only circuit implementations (such as implementations in only analog and/or digital circuitry) and

(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and

(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware.

As used in this application, the expression ‘electrically connected’ refers to a direct electrical connection between two elements, with no intervening elements therebetween, or an indirect electrical connection between two elements, with one or more intervening elements therebetween.

The blocks illustrated in FIGS. 10, 3 and 6 may represent steps in a method. The illustration of a particular order to the blocks does not necessarily imply that there is a required or preferred order for the blocks and the order and arrangement of the block may be varied. Furthermore, it may be possible for some blocks to be omitted.

Although embodiments of the present invention have been described in the preceding paragraphs with reference to various examples, it should be appreciated that modifications to the examples given can be made without departing from the scope of the invention as claimed. For example, it was mentioned above that the touch sensitive display apparatus 103 illustrated in FIG. 10 may comprise the first embodiment 101 of the apparatus. If so, the polarizer 36 may be attached to an upper surface of the trace layer 14 and the guard layer 32 may be attached to a lower face/surface of the substrate 15. It will also be apparent that the apparatuses 100/101/102 illustrated in FIGS. 1A, 2, 4C, 5C, 7, 8A to 8C and 9A to 9C could be used in a touch sensitive display which has a different structure (and potentially different components) from the touch sensitive display apparatus 103 illustrated in FIG. 10.

In some embodiments of the invention, the sensors 22 may be split across multiple sensing layers. For example, half of the sensors could be located in a first sensing layer and half of the sensors could be located in a second sensing layer, positioned below the first sensing layer. Each sensing layer may have its own insulating layer and its own trace layer. In such embodiments, the sensors in the first sensing layer are positioned such that they overlie the traces in the trace layer associated with the first sensing layer, but not the sensors in the second sensing layer. The sensors in the second sensing layer overlie the traces in the trace layer associated with the second sensing layer.

In some instances, the traces 24 may be aligned with the width of the substrate 15 rather than the length of the substrate 15.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the applicant claims protection in respect of any patentable feature or combination of features hereinbefore referred to and/or shown in the drawings whether or not particular emphasis has been placed thereon.

I/We claim:

1. An apparatus, comprising:
a sensing layer comprising an array of touch sensors for sensing touch input; and
a trace layer comprising a plurality of traces that electrically connect the touch sensors to sensing circuitry, wherein the array of touch sensors in the sensing layer is positioned to electromagnetically shield the plurality of traces, in the trace layer, from conductive user input objects.

2. The apparatus as claimed in claim 1, wherein the sensing layer is positioned between an outer surface of the apparatus and the trace layer.

3. The apparatus as claimed in claim 2, wherein the outer surface of the apparatus is an outer surface of a display window.

4. The apparatus as claimed in claim 1, 2 or 3, wherein the sensing layer and the trace layer are supported by a substrate.

5. The apparatus as claimed in claim 4, wherein the sensing layer is positioned between the substrate and the trace layer.

6. The apparatus as claimed in claim 4, wherein the trace layer is positioned between the sensing layer and the substrate.

7. The apparatus as claimed in any of the preceding claims, wherein an insulating layer is positioned between the sensing layer and the trace layer.

8. The apparatus as claimed in claim 7, wherein the insulating layer insulates traces in the trace layer from touch sensors in the sensing layer.

9. The apparatus as claimed in claim 7 or 8, wherein individual traces in the trace layer electrically connect to touch sensors in the sensing layer through apertures in the insulating layer.

10. The apparatus as claimed in any of the preceding claims, wherein the traces electrically connect the touch sensors to sensing circuitry individually.

11. The apparatus as claimed in any of the preceding claims, wherein an individual trace is provided in the trace layer for each and every one of the touch sensors in the array, and each individual trace connects a touch sensor in the array to sensing circuitry.

12. A method, comprising:
forming a sensing layer comprising an array of touch sensors for sensing touch input; and
forming a trace layer comprising a plurality of traces that electrically connect the touch sensors to sensing circuitry, wherein the array of touch sensors in the sensing layer is positioned to electromagnetically shield the plurality of traces, in the trace layer, from conductive user input objects.

13. The method as claimed in claim 12, wherein the sensing layer is formed prior to the trace layer being formed.

14. The method as claimed in claim 13, where the sensing layer is formed on a substrate.

15. The method as claimed in claim 14, further comprising: forming an insulating layer on the sensing layer, wherein the trace layer is formed on the insulating layer.

16. The method as claimed in claim 15, wherein the insulating layer insulates traces in the trace layer from touch sensors in the sensing layer.

17. The method as claimed in claim 12, wherein the trace layer is formed prior to the sensing layer being formed.

18. The method as claimed in claim 17, wherein the trace layer is formed on a substrate.

19. The method as claimed in claim 18, further comprising: forming an insulating layer on the trace layer, wherein the sensing layer is formed on the insulating layer.

20. The method as claimed in claim 19, wherein the insulating layer insulates traces in the trace layer from touch sensors in the sensing layer.

21. The method as claimed in any of claims 12 to 20, wherein individual traces in the trace layer electrically connect to touch sensors in the sensing layer through apertures in the insulating layer.

22. The method as claimed in claim 21, wherein the traces electrically connect the touch sensors to sensing circuitry individually.

23. The method as claimed in any of claims 12 to 22, wherein an individual trace is provided in the trace layer for each and every one of the touch sensors in the array, and each individual trace connects a touch sensor in the array to sensing circuitry.

24. The method as claimed in any of claims 12 to 23, wherein the sensing layer is positioned between an outer surface of the apparatus and the trace layer.

25. The method as claimed in claim 24, wherein the outer surface of the apparatus is an outer surface of a display window.
